(19) United States
(12) Patent Application Publication
(10) Pub. No.: US 2014/0069729 A1
(43) Pub. Date: Mar. 13, 2014

(54) REAL-TIME WEIGHT MEASURING SYSTEM FOR HOSPITAL BED

(71) Applicant: Boris SHIH, Taipei City (TW)

(72) Inventor: Boris SHIH, Taipei City (TW)

(73) Assignee: CAREMED SUPPLY INC., New Taipei City (TW)

(21) Appl. No.: 13/608,440

(22) Filed: Sep. 10, 2012

(51) Int. Cl. G01G 19/52

(52) U.S. Cl. 177/144

(57) ABSTRACT

A weight measuring system for hospital bed includes a bed bottom frame having two load cell mounting spaces formed at a front end and a rear end of the bed bottom frame between a first and a second supporting frame thereof; and a plurality of load cells mounted on the bed bottom frame to locate in the two load cell mounting spaces. Each load cell includes a supporting unit and at least one strain measurement unit attached to a lateral surface of the supporting unit for measuring an extent of strain elongation of the supporting unit under a bedridden patient's weight. With these arrangements, a nurse can not only measure a bedridden patient's weight without the need of moving the patient, but also monitor the patient's movement on the hospital bed in real time, preventing the patient from getting out of bed alone or carelessly falling off the hospital bed.

### FIELD OF THE INVENTION

The present invention relates to a weight measuring system directly mounted on a hospital bed, and more particularly to a real-time weight measuring system that allows a nurse to directly measure a bedridden patient's body weight and monitor the patient's movement on the hospital bed synchronously.

### BACKGROUND OF THE INVENTION

It is very difficult to measure a patient's body weight when the patient lying on a hospital bed can not move on bed by himself or herself due to illness or injury. To enable convenient measurement of a bedridden patient's body weight, various types of weight measuring devices have been developed and introduced into the market.

FIG. 1 shows a conventional weighing device 10 for use with a wheel-supported bed. To measure a bedridden patient's body weight, first mount one weighing device 10 below each of four wheels 11 of a hospital bed. The loads measured by all the weighing devices 10 are summed and a net weight of the hospital bed is deducted from the measured total load to obtain the patient's body weight without the need of moving the patient off the bed.

However, while the weighing devices 10 together enable measurement of a patient's body weight without the need of moving the patient off the bed, they must be positioned below the four wheels 11 of the hospital bed before they can work to measure the patient's weight. Any additional time needed to locate the weighing devices 10 below the wheels 11 of the hospital bed would very possibly reduce the chance of saving the patient's life during emergent medical care. Further, not all the currently available hospital beds are same in structural design and weight. Thus, it is necessary to change the settings in the weighing devices 10 when they are used with differently designed hospital beds to thereby cause inconvenience in use.

Moreover, the above-described weighing devices 10 can only be used to measure the bedridden patient's body weight without the function of real-time monitoring of the patient's lying condition on the bed. For a patient suffering from some special disease, the nurse has to know not only the patient's body weight, but also whether the patient keeps the same lying position on the hospital bed, so as to prevent the patient from arbitrarily getting out of the bed without being accompanied by the nurse or from carelessly falling off the bed.

In view that the conventional weighing device for hospital bed is not convenient for use and fails to satisfy the requirement for monitoring a patient lying on the bed, it is desirable to develop an improved weight measuring system for hospital bed.

### SUMMARY OF THE INVENTION

A primary object of the present invention is to provide a weight measuring system directly mounted on a hospital bed for measuring a bedridden patient's body weight in real time without the need of moving the patient.

Another object of the present invention is to provide a real-time weight measuring system for hospital bed, so that a nurse can monitor a bedridden patient's movement on the hospital bed at any time to prevent the patient from getting out of bed without being accompanied by a nurse or carelessly falling off the hospital bed.

To achieve the above and other objects, the real-time weight measuring system for hospital bed according to the present invention includes a bed bottom frame and a plurality of load cells mounted on the bed bottom frame. The bed bottom frame includes a first supporting frame and a second supporting frame connected to and located around an outer side of the first supporting frame, such that a load cell mounting space is formed at each of a front end and a rear end of the bed bottom frame between the first and the second supporting frame, and each load cell mounting space has at least one load cell located therein.

Preferably, the load cells are located in the two load cell mounting spaces near left and right ends thereof, and accordingly located close to four corners of the bed bottom frame. According to a preferred embodiment of the present invention, the real-time weight measuring system for hospital bed further includes at least one first mounting bracket connected to a top of the first supporting frame to extend into each of the two load cell mounting spaces; and at least one second mounting bracket connected to a bottom of the second supporting frame to extend into each of the two load cell mounting spaces; and each of the load cells is mounted to between one first mounting bracket and one second mounting bracket.

In the preferred embodiment, the first mounting bracket and the second mounting bracket for together holding one load cell thereto between are offset from each other in position, so that the load cell has a first end locked to the first mounting bracket and a second end locked to the second mounting bracket.

In the present invention, each of the load cells includes a supporting unit, at least one strain measurement unit, at least one fixing bolt, and a height-adjusting bolt. The supporting unit is locked to between the first mounting bracket and the second mounting bracket, and the strain measurement unit is arranged on a lateral surface of the supporting unit for measuring an extent of strain elongation of the supporting unit under pressure. The fixing bolt and the height-adjusting bolt are separately fixed to a top surface of the supporting unit near two opposite ends thereof.

According to the preferred embodiment of the present invention, the real-time weight measuring system for hospital bed further includes a bed frame assembled to a top of the bed bottom frame, and the load cells are upward pressed against edge areas of the bed frame.

The real-time weight measuring system for hospital bed according to the present invention is characterized in having load cells mounted to between two supporting frames of the bed bottom frame and upward pressed against the bed frame mounted atop the bed bottom frame, so that any deformation of the load cells under the bedridden patient's body weight can be directly used to determine the patient's weight without the need of moving the patient. Further, the extent of deformation of the load cells can also be used to detect whether there is a patient lying on the hospital bed, so as to monitor the movement or lying condition of the bedridden patient in real time.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view showing a conventional weighing device for hospital bed;

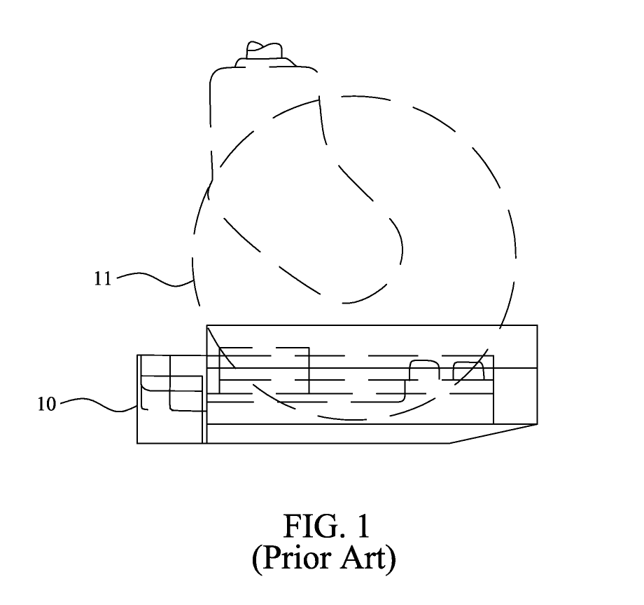

FIG. 2 is an assembled perspective view of a real-time weight measuring system for hospital bed according to a preferred embodiment of the present invention;

FIG. 3 is a partially enlarged view of the real-time weight measuring system for hospital bed of FIG. 2 showing an end position of a bed bottom frame thereof;

FIG. 4 is a partially exploded view of FIG. 3;

FIG. 5 shows the use of a processing unit to collect and monitor weight-related data measured by load cells of the real-time weight measuring system for hospital bed according to the present invention;

FIG. 6 is a top plan view showing a patient lying on a hospital bed with the real-time weight measuring system of the present invention; and

FIG. 7 is a top plan view indicating a center of mass of a patient's body on a hospital bed derived with the real-time weight measuring system for hospital bed according to the present invention.

### DETAILED DESCRIPTION OF THE PREFERRED EMBODIMENTS

The present invention will now be described with a preferred embodiment thereof and with reference to the accompanying drawings.

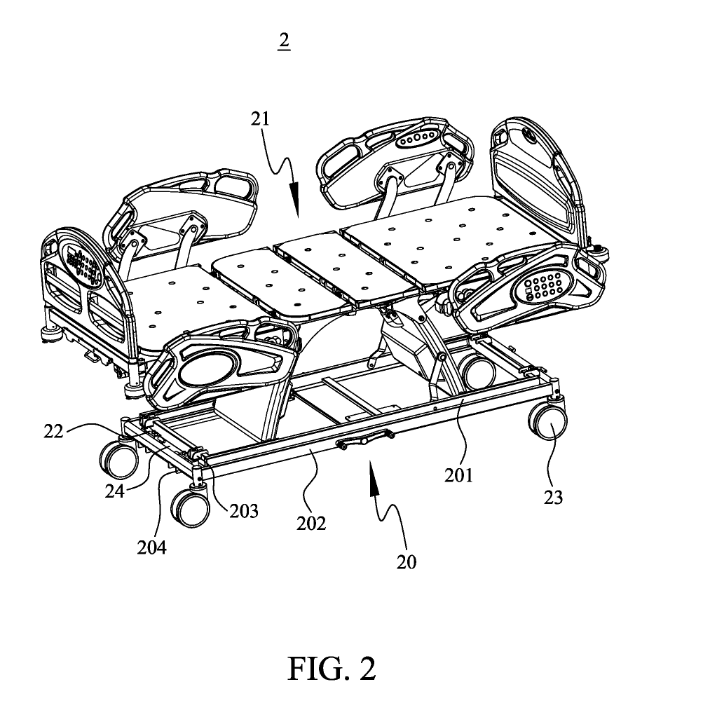

Please refer to FIG. 2 that is an assembled perspective view of a real-time weight measuring system for hospital bed according to a preferred embodiment of the present invention. As shown, the real-time weight measuring system includes a hospital bed structure 2 having a bed bottom frame 20 and a bed frame 21, and a plurality of load cells 22 mounted on the hospital bed structure 2 for measuring the body weight of a patient lying on the hospital bed structure 2 and for real-time monitoring of the patient's lying condition on the hospital bed structure 2. The bed frame 21 is not necessarily limited to any particular type or specification but may be differently designed in structure and appearance according to actual need in use, so long as it is made of a light but rigid enough material.

The bed bottom frame 20 includes a first supporting frame 201 configured as a rectangular frame, and a second supporting frame 202 also configured as a rectangular frame. The bed frame 21 is assembled to an inner side of the first supporting frame 201 to locate atop the bed bottom frame 20; and the second supporting frame 202 is provided below four corners with a caster 23 each. The second supporting frame 202 has length and width slightly larger than those of the first supporting frame 201 and is connected to and located around an outer side of the first supporting frame 201, such that a load cell mounting space 24 is formed at each of a front end and a rear end of the bed bottom frame 20 between the first and the second supporting frame 201, 202. In each of the two load cell mounting spaces 24, there is one load cell 22 arranged near each of a left and a right end thereof, so that the load cells 22 are located close to four corners of the bed bottom frame 20. With these arrangements, a distance between each load cell 22 and a center of mass of the patient lying on the bed is maximized to enable increased measuring accuracy.

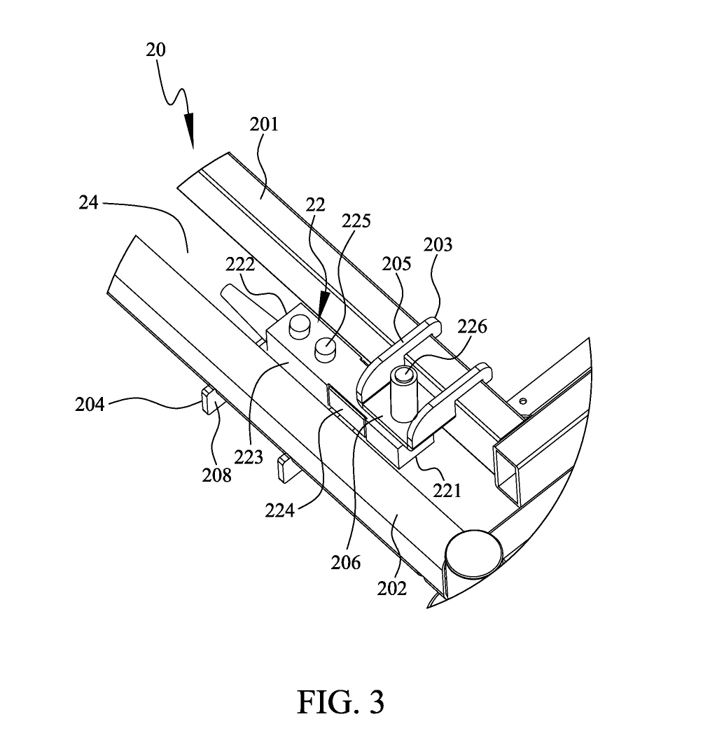

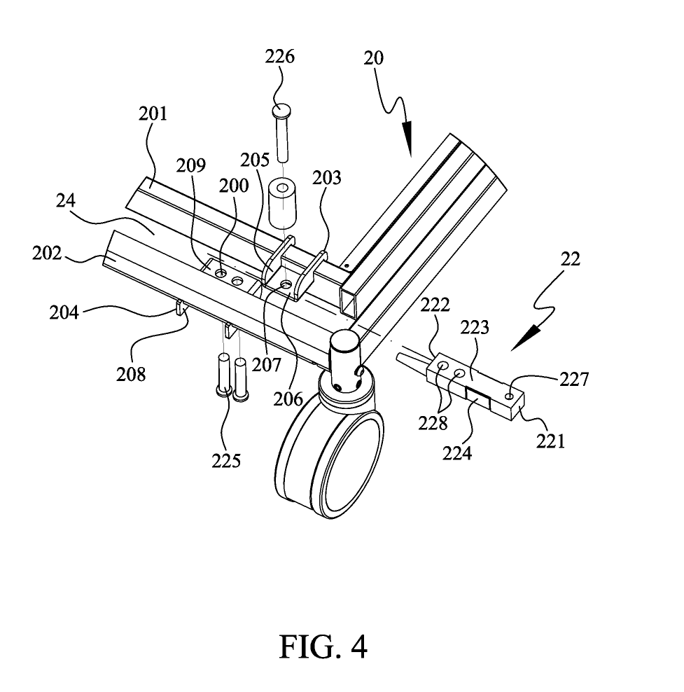

Please refer to FIG. 3. At least one first mounting bracket 203 is connected to a top of the first supporting frame 201 to extend into each load cell mounting space 24; and at least one second mounting bracket 204 is connected to a bottom of the second supporting frame 202 to extend into each load cell mounting space 24. Each of the load cells 22 is mounted to between one first mounting bracket 203 and one second mounting bracket 204. As can be seen in FIGS. 3 and 4, the first mounting bracket 203 and the second mounting bracket 204 for together holding one load cell 22 thereto between are offset from each other in position, so that the load cell 22 has a first end 221 locked to the first mounting bracket 203 and a second end 222 locked to the second mounting bracket 204.

Please refer to FIG. 4. In the illustrated preferred embodiment, the first mounting bracket 203 has two parallelly extended first ribs 205 and a bottom plate 206 extended between and connected to the two first ribs 205 and having an opening 207 formed thereon; and the second mounting bracket 204 has two parallelly extended second ribs 208 and a top plate 209 extended between and connected to the two second ribs 208 and having two openings 200 formed thereon.

Each of the load cells 22 includes a supporting unit 223, two strain measurement units 224, two fixing bolts 225, and a height-adjusting bolt 226. The supporting unit 223 is provided near an end with a hole 227 corresponding to the opening 207 formed on the bottom plate 206 of the first mounting bracket 203, and near another opposite end with two holes 228 corresponding to the two openings 200 formed on the top plate 209 of the second mounting bracket 204.

The two strain measurement units 224 are arranged on two opposite lateral surfaces of the supporting unit 223 for measuring an extent of strain elongation of the supporting unit 223 under pressure. From the measured strain elongation, the weight applied to the supporting unit 223 can be derived. In an operable embodiment, the strain measurement units 224 are attached to the middle areas on the two opposite lateral surfaces of the supporting unit 223.

The two fixing bolts 225 and the height-adjusting bolt 226 are fixed to a top of the supporting unit 223 at the two holes 228 and the hole 227, respectively, formed near two ends of the supporting unit 223. The fixing bolts 225 lock one end of the supporting unit 223 to the second mounting bracket 204, such that the other end of the supporting unit 223 is extended beyond the second mounting bracket 204 to suspend in the load cell mounting space 24. Therefore, the suspended end of the supporting unit 223 will be downward pressed and become deformed when it is subjected to an additional weight. The height-adjusting bolt 226 can be adjusted for the load cell 22 to exactly contact with the bed frame 21 for bearing the weight of the bed frame 21.

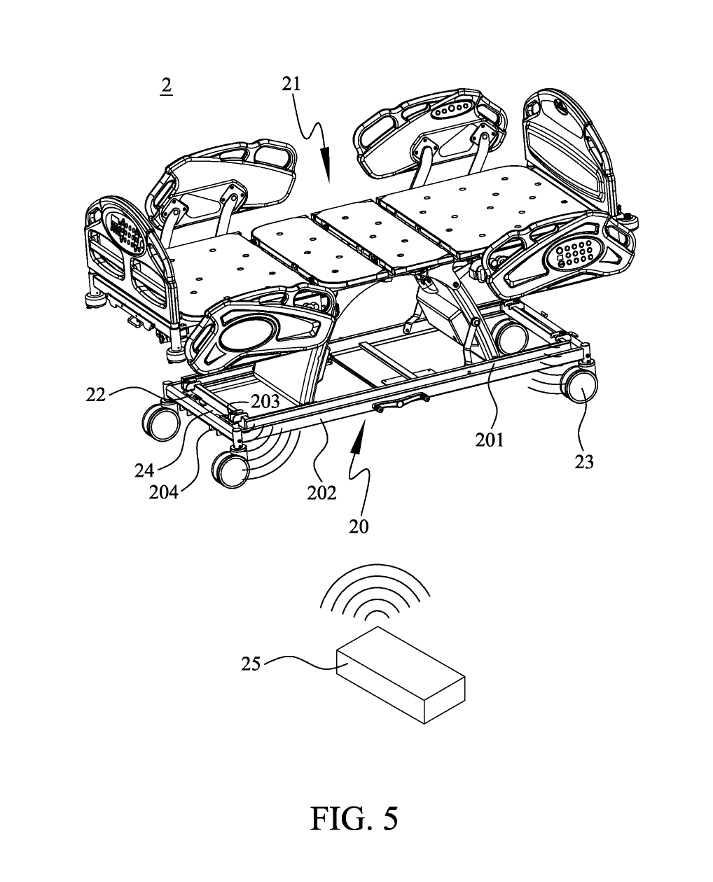

Please refer to FIG. 5. The real-time weight measuring system for hospital bed according to the present invention further includes a processing unit 25 linked to the load cells 22 for collecting, sorting and calculating data related to the weights measured at the load cells 22. The processing unit 25 can be set to collect the weight-related data from the load cells 22 periodically or at predetermined time points, so as to obtain information about the patient's lying condition on the hospital bed structure 2 in real time. The information about the patient's lying condition on the hospital bed can be used not only to analyze changes in the patient's weight (i.e. weight gain or loss), but also to monitor the patient's movement on the hospital bed. Any real-time data or signal collected from the load cells 22 indicates that the patient intends to get out of bed or shows any other abnormal movement, a warning is emitted immediately to remind a nurse of such condition.

In the illustrated preferred embodiment, the processing unit 25 is wirelessly linked to the load cells 22. However, the preferred embodiment is only illustrative and not intended to restrict the present invention in any way. That is, the processing unit 25 can be otherwise linked to the load cells 22 in a wired manner (not shown).

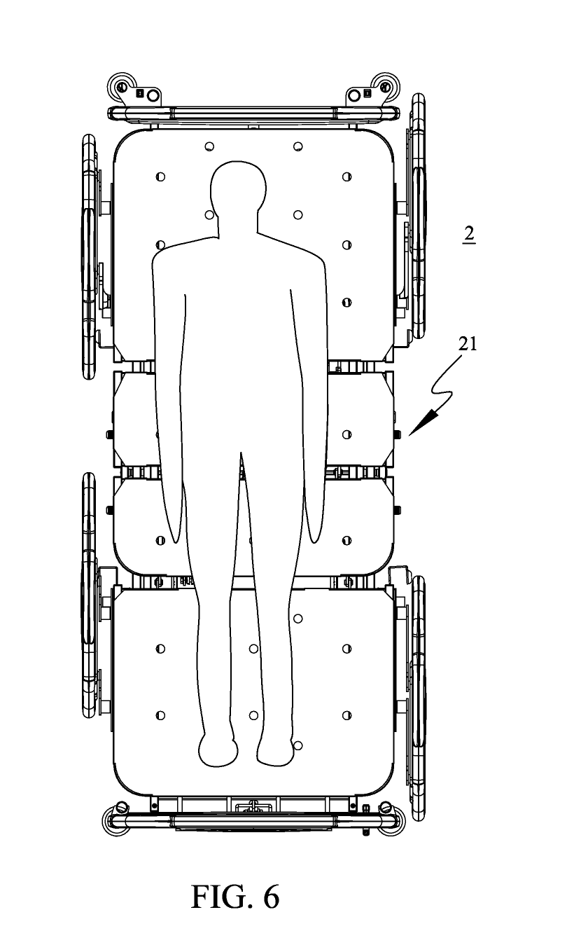

Please refer to FIG. 6. When the patient is lying on the hospital bed structure 2 according to the real-time weight measuring system of the present invention, the patient's body weight is evenly distributed over the bed frame 21. However, the weights bearing by and measured at the load cells 22 vary with the distances between the load cells 22 and the patient's center of mass and the patient's position on the bed frame 21. On receipt of data of weights measured by and at the load cells 22, the processing unit 25 sorts and calculates the data to derive the patient's position on the bed frame 21.

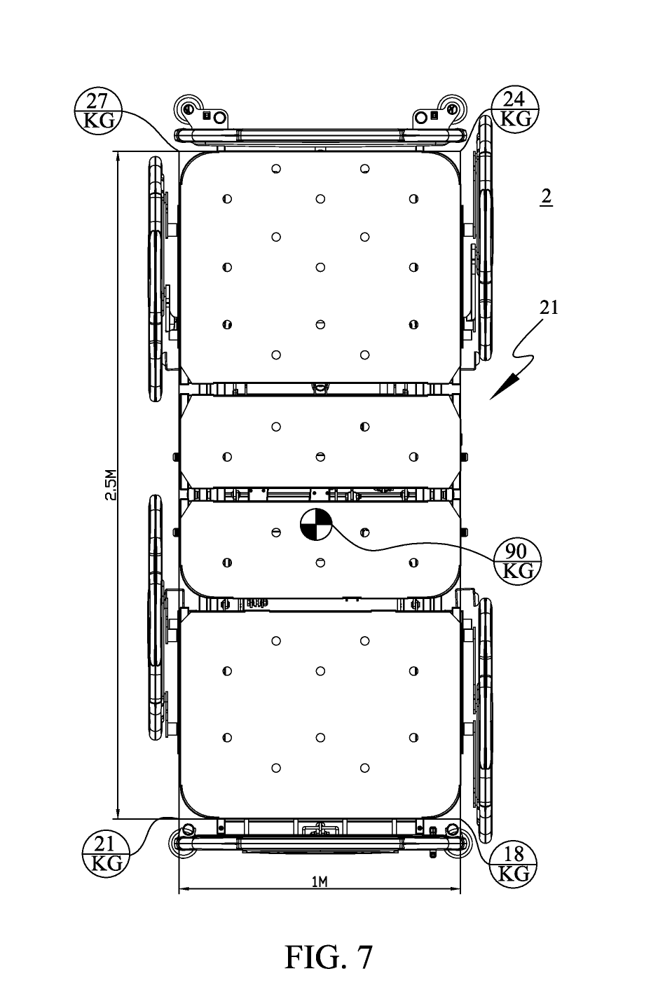

Please refer to FIG. 7. According to an operable embodiment, the bed frame 21 has a length of 2.5 meters and a width of 1.0 meter. As shown, weight data measured at the load cells 22 located at four corners of the bed frame 21 are 27 kg, 24 kg, 21 kg and 18 kg. The processing unit 25 calculates based on the received data to determine the patient's body weight is 90 kg, and the patient's center of mass is currently located at a point on the bed frame 21 about 108 cm in longitudinal direction and 47 cm in transverse direction away from a rear left corner of the bed frame 21. When the patient gets out of the bed frame 21, the weight data measured at all the load cells 22 are zero, and the processing unit 25 is caused to emit a warning for reminding the nurse that the patient is not lying on the bed.

In brief, the present invention is characterized by providing a plurality of load cells directly on a bed bottom frame between two supporting frames thereof, so that changes in the body weight of a bedridden patient and in the patient's center of mass on the bed can be directly measured and detected via the load cells in real time. The present invention not only largely increases the convenience in measuring the bedridden patient's body weight, but also enables medical persons and nurses to monitor the patient's movement on the bed at any time to prevent the patient from getting out of bed without being accompanied by a nurse or carelessly falling off the hospital bed.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A real-time weight measuring system for hospital bed, comprising:
a bed bottom frame including a first supporting frame and a second supporting frame mounted to and located around an outer side of the first supporting frame, such that two load cell mounting spaces are formed at a front end and a rear end of the bed bottom frame between the first and the second supporting frame; and
a plurality of load cells being mounted on the bed bottom frame to locate in the two load cell mounting spaces.

2. The real-time weight measuring system for hospital bed as claimed in claim 1, wherein the load cells are located in the two load cell mounting spaces near left and right ends thereof, and accordingly located close to four corners of the bed bottom frame.

3. The real-time weight measuring system for hospital bed as claimed in claim 1, wherein each of the load cells includes a supporting unit and a strain measurement unit; and the strain measurement unit being arranged on a lateral surface of the supporting unit for measuring an extent of strain elongation of the supporting unit under pressure.

4. The real-time weight measuring system for hospital bed as claimed in claim 1, further comprising at least one first mounting bracket connected to a top of the first supporting frame to extend into each of the two load cell mounting spaces; and at least one second mounting bracket connected to a bottom of the second supporting frame to extend into each of the two load cell mounting spaces; and each of the load cells being mounted to between one first mounting bracket and one second mounting bracket.

5. The real-time weight measuring system for hospital bed as claimed in claim 4, wherein the first mounting bracket and the second mounting bracket for together holding one load cell thereto between are offset from each other in position, so that the load cell has a first end locked to the first mounting bracket and a second end locked to the second mounting bracket.

6. The real-time weight measuring system for hospital bed as claimed in claim 4, wherein each of the load cells includes a supporting unit and at least one strain measurement unit; the supporting unit being locked to between the first mounting bracket and the second mounting bracket, and the strain measurement unit being arranged on a lateral surface of the supporting unit for measuring an extent of strain elongation of the supporting unit under pressure.

7. The real-time weight measuring system for hospital bed as claimed in claim 6, wherein each of the load cells further includes at least one fixing bolt and a height-adjusting bolt; and the fixing bolt and the height-adjusting bolt being separately fixed to a top surface of the supporting unit near two opposite ends thereof.

8. The real-time weight measuring system for hospital bed as claimed in claim 1, further comprising a processing unit electrically linked to each of the load cells.

9. The real-time weight measuring system for hospital bed as claimed in claim 1, further comprising a bed frame assembled to a top of the bed bottom frame, and the load cells being upward pressed against edge areas of the bed frame.
